(19) United States
(12) Patent Application Publication
(10) Pub. No.: US 2014/0327743 A1
(43) Pub. Date: Nov. 6, 2014

(54) AUTO FOCUS METHOD AND AUTO FOCUS APPARATUS

(71) Applicant: Altek Semiconductor Corp., Hsinchu City (TW)

(72) Inventors: Hong-Long Chou, Taipei City (TW); Chung-Chia Kang, Tainan City (TW); Wen-Yan Chang, Miaoli County (TW); Yu-Chen Huang, Hsinchu County (TW)

(21) Appl. No.: 13/914,639

(22) Filed: Jun. 11, 2013

(30) Foreign Application Priority Data
May 2, 2013 (TW) 102115729

(51) Int. Cl. H04N 13/02

(52) U.S. Cl. CPC H04N 13/0242
USPC 348/47

(57) ABSTRACT

An auto focus (AF) method and an AF apparatus are provided. The method includes the following steps. At least one target object is selected and photographed by a first image sensor and a second image sensor to generate a three-dimensional (3D) depth map. A block covering at least one initial focusing point is selected. The 3D depth map is queried for reading depth information of a plurality of pixels in the block. It is determined whether depth information of the pixels is enough to operate. If yes, a first statistics operation is performed, and focusing depth information is obtained. If not, the position of the block is moved or the size of the block is enlarged to obtain the focusing depth information. A focusing position is obtained according to the focusing depth information and the AF apparatus is driven to perform an AF procedure according to the focusing position.

### CROSS-REFERENCE TO RELATED APPLICATION

This application claims the priority benefit of Taiwan application serial no. 102115729, filed on May 2, 2013. The entirety of the above-mentioned patent application is hereby incorporated by reference herein and made a part of this specification.

### BACKGROUND OF THE INVENTION

1. Field of the Invention

The present invention generally relates to an auto focus (AF) technique, and more particularly, to an AF method and an AF apparatus adopting a stereoscopic image processing technique.

2. Description of Related Art

Generally, an AF technique refers to that a digital camera moves its lens to change a distance between the lens and an object to be photographed, and repeatedly calculates a focus evaluation values (referred to as focusing values in brief hereinafter) of a captured image according to the position of the lens, until the maximum focusing value is determined. To be specific, the maximum focus value of a lens allows a clearest image of the object to be photographed at the current position of the lens.

However, in the hill-climbing technique or regression technique adopted by the existing AF technique, every focusing action requires the lens to be continuously moved and multiple images to be captured to search for the maximum focus value. Thus, it is very time-consuming. Moreover, when a digital camera moves its lens, the lens may be moved too much therefore has to be moved back and forth. As a result, a phenomenon named “Breathing” may be produced. The phenomenon of breathing refers to the change of angle of view of a lens when shifting the focus and therefore destroys the stability of the image. Presently, an AF technique adopting the stereoscopic vision technique for processing images is provided. This AF technique may effectively shorten the focusing time and eliminate the phenomenon of breathing and can increase the focusing speed and image stability therefore becomes increasingly popular in the related field.

However, generally speaking, when the current 3D coordinate position information of each pixel in an image is obtained through image processing of the present stereoscopic vision technique, the position of each point in the image cannot be determined precisely. Moreover, since it is difficult to identify relative depth or precisely determine depth information of each point in a texture-less or flat area, etc., “holes” may be produced in a 3D depth map. In addition, if the AF technique is applied to a handheld electronic device (for example, a smart phone), in order to minimize the size of the product, a stereo baseline of the product has to be reduced as much as possible. As a result, precise positioning may become even more difficult, and more holes may be produced in the 3D depth map. Moreover, the execution of subsequent image focusing procedures may be affected. Therefore, it is an important issue for related researchers to give consideration to focusing speed, stability of images and accuracy of focus positioning of the AF technique.

### SUMMARY OF THE INVENTION

The present invention is directed to an auto focus (AF) method and an AF apparatus which offer fast speed of auto focusing, optimal image stability and optimal focus positioning accuracy.

The present invention provides an AF method adapted to an AF apparatus which has a first image sensor and a second image sensor. The AF method includes following steps. At least one target object is selected and photographed by the first image sensor and the second image sensor to perform a procedure of three-dimensional (3D) depth estimation, so as to generate a 3D depth map. A block covering at least one initial focusing point is selected according to at least one initial focusing point of the target object. The 3D depth map is queried to read pieces of depth information of a plurality of pixels in the block. It is determined whether the pieces of depth information of the pixels are enough to operate. If yes, a first statistics operation is performed on the pieces of depth information of the pixels to obtain a piece of focusing depth information. If not, the position of the block is moved or the size of the block is enlarged to obtain the piece of focusing depth information. A focusing position regarding the target object is obtained according to the piece of focusing depth information, and the AF apparatus is driven to perform an AF procedure according to the focusing position.

In an embodiment of the present invention, the step of determining whether the depth information of the pixels is enough to operate includes following steps. It is determined whether the piece of depth information of each pixel is a piece of valid depth information, and if yes, the pixel is determined to be a valid pixel. Moreover, it is determined whether a quantity of the valid pixels or a ratio between the valid pixels and the pixels is greater than a predetermined ratio threshold.

In an embodiment of the present invention, after the step of enlarging the size of the block, the AF method further includes determining whether the size of the block is greater than a predetermine range threshold. If not, it is returned to the step of determining whether the pieces of depth information of the pixels are enough to operate. If yes, it is determined that the focusing is failed, and the AF apparatus is driven to perform a pan-focusing procedure, or to perform an AF procedure of contrast type focusing, or does not perform focusing.

In an embodiment of the present invention, the method for selecting the at least one target object includes following steps. At least one click signal for selecting the at leas one target object is received from a user through the AF apparatus, or an object detecting procedure is executed through the AF apparatus to automatically select the at least one target object, and a coordinate position of the at least one initial focusing point is obtained.

In an embodiment of the present invention, when the at least one target object are a plurality of target objects, the step of obtaining the focusing position regarding the target objects includes following steps. The pieces of focusing depth information of the target objects are calculated to obtain average focusing depth information. A focal range is calculated according to the average focusing depth information. It is determined whether the target objects are all within the focal range. If yes, the focusing position regarding the target objects is obtained according to the average focusing depth information.

In an embodiment of the present invention, when the at least one target object are a plurality of target objects, the AF method further includes following steps. A target object position discrete test is executed and it is determined whether the coordinate positions of the target objects are discrete.

In an embodiment of the present invention, the target object position discrete test is a standard deviation test, a variance test or an entropy test.

In an embodiment of the present invention, when it is determined that the coordinate positions of the target objects are discrete, the step of obtaining the focusing position regarding the target objects includes following steps. A maximum target object is selected from the target objects, wherein the maximum target object has characteristic focusing depth information. The focusing position regarding the target objects is obtained according to the characteristic focusing depth information.

In an embodiment of the present invention, when it is determined that the coordinate positions of the target objects are convergent, the step of obtaining the focusing position regarding the target objects includes following steps. Each piece of focusing depth information of the target objects is obtained. A second statistics operation is performed on the pieces of focusing depth information to obtain characteristic focusing depth information, wherein the second statistics operation is a mod operation. The focusing position regarding the target objects is obtained according to the characteristic focusing depth information.

In an embodiment of the present invention, the first statistics operation is a mean operation, a mod operation, a median operation, a minimum value operation or a quartile operation.

The present invention provides an AF apparatus including a first image sensor, a second image sensor, a focusing module and a processing unit. The first image sensor and the second image sensor photograph at least one target object. The focusing module controls a focusing position of the first image sensor and the second image sensor. The processing unit is coupled to the first image sensor, the second image sensors and the focusing module, wherein the processing unit includes a block depth estimator and a depth information determination module. The block depth estimator performs a procedure of 3D depth estimation to generate a 3D depth map, selects a block covering at least one initial focusing point according to the at least one initial focusing point of the target object, and queries the 3D depth map for reading pieces of depth information of a plurality of pixels in the block. The depth information determination module is coupled to the block depth estimator, and determines whether the pieces of depth information of the pixels are enough to operate. If not, the block depth estimator moves the position of the block or enlarge the size of the block for reading the pieces of depth information of the pixels in the block. If yes, the processing unit drives the block depth estimator to perform a first statistics operation on the pieces of depth information of the pixels to obtain a piece of focusing depth information. The processing unit obtains a focusing position regarding the at least one target object according to the piece of focusing depth information and drives the AF apparatus to perform an AF procedure according to the focusing position.

According to the above descriptions, in the AF method and the AF apparatus provided by the present invention, a 3D depth map is generated through a stereoscopic image processing technique. Besides, the piece of depth information of each pixel in the 3D depth map is determined and statistics operations are performed to obtain the focusing position. Thus, the AF apparatus and the AF method provided by the present invention not only can be performed within a single image shooting period, but also resolve the problem of focusing error caused by depth information “holes” in the 3D depth map. Moreover, the AF apparatus and the AF method provided by the present invention can also execute different statistics operation methods on the piece of depth information of each pixel in the block to calculate a piece of suitable focusing depth information. Thereby, the AF apparatus and the AF method provided by the present invention have a faster speed of auto focusing and optimal image stability, and also have optimal focus positioning accuracy.

These and other exemplary embodiments, features, aspects, and advantages of the invention will be described and become more apparent from the detailed description of exemplary embodiments when read in conjunction with accompanying drawings

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an auto focus (AF) apparatus according to an embodiment of the invention.

FIG. 2A is a flowchart illustrating an AF method according to an embodiment of the invention.

FIG. 2B is a flowchart illustrating steps of producing a 3D depth map according to the embodiment of FIG. 2A.

FIG. 2C is a schematic diagram of depth searching according to the embodiment of FIG. 2A.

FIG. 2D is a flowchart illustrating steps of determining whether depth information of pixels is enough to operate according to the embodiment of FIG. 2A.

FIG. 3A is a flowchart illustrating an AF method according to anther embodiment of the invention.

FIG. 3B is a flowchart illustrating a method of obtaining a focusing position regarding target objects according to the embodiment of FIG. 3A.

FIG. 4 is a block diagram of an AF apparatus according to another embodiment of the invention.

FIG. 5 is a flowchart illustrating another method of obtaining the focusing position regarding the target objects according to the embodiment of FIG. 3A.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

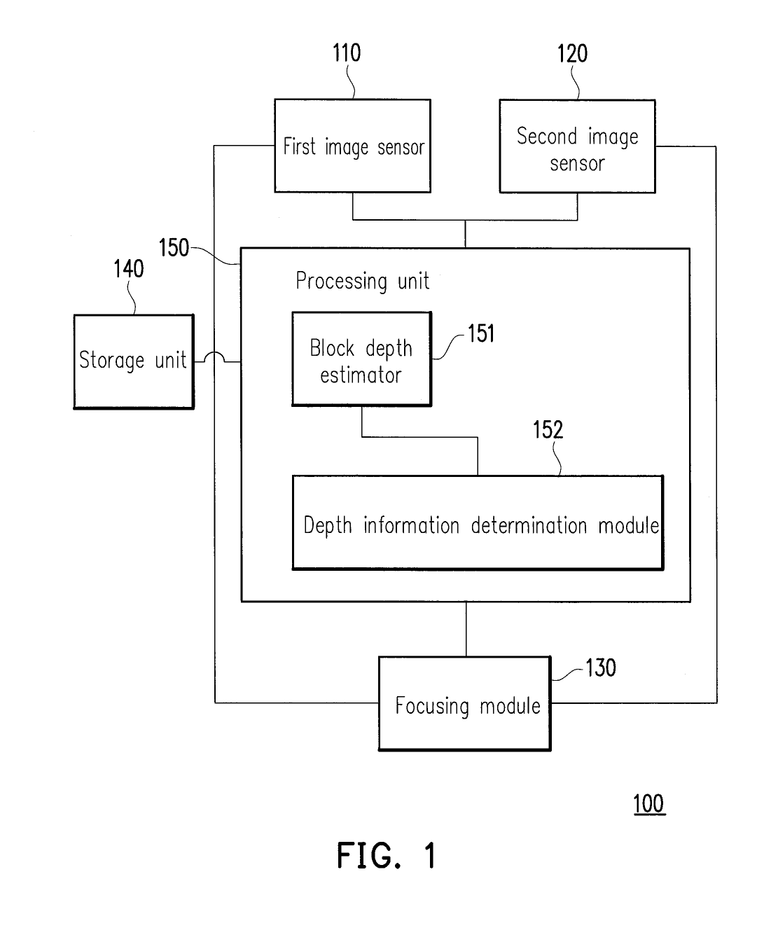

FIG. 1 is a block diagram of an auto focus (AF) apparatus according to an embodiment of the invention. Referring to FIG. 1, the AF apparatus 100 in the present embodiment includes a first image sensor 110, a second image sensor 120, a focusing module 130, a storage unit 140 and a processing unit 150. The processing unit 150 includes a block depth estimator 151 and a depth information determination module 152. In the present embodiment, the AF apparatus 100 is, for example, a digital camera, a digital video camcorder (DVC) or any other handheld electronic device which can be used for capturing videos or photos. However, the type of the AF apparatus 100 is not limited in the present invention. On the other hand, in the present embodiment, the first image sensor 110 and the second image sensor 120 may respectively include respectively might include elements, such as a lens, a photo sensing device or an aperture, etc. which are used to capture images. Moreover, the focusing module 130, the storage unit 140, the processing unit 150, the block depth estimator 151 and the depth information determination module 152 can be functional modules implemented as hardware and/or software, wherein the hardware may be any one or a combination of hardware devices, such as a central processor (CPU), a system on chip (SOC), an application specific integrated circuit (ASIC), a digital signal processor (DSP), a chipset, a microprocessor, and the software can be an operating system (OS), a driving programs.

In the present embodiment, the processing unit 150 is coupled to the first image sensor 110, the second image sensor 120, the focusing module 130 and the storage unit 140. The processing unit 150 controls the first image sensor 110, the second image sensor 120 and the focusing module 130, and stores related information in the storage unit 140. The processing unit 150 also drives the block depth estimator 151 and the depth information determination module 152 to execute related instructions.

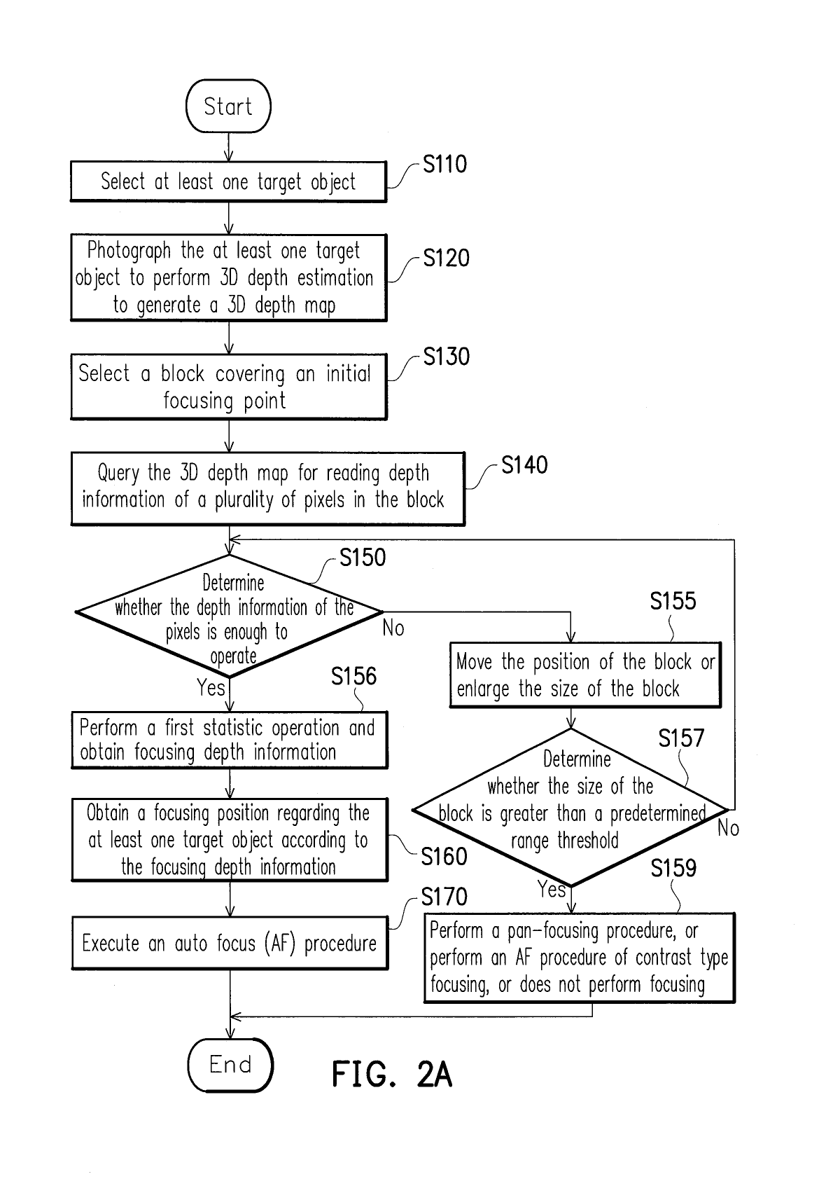

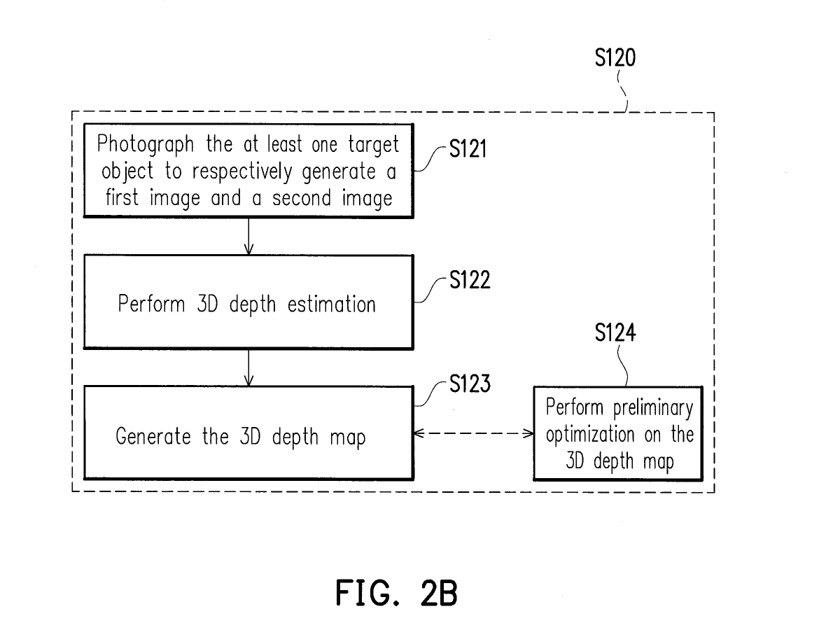

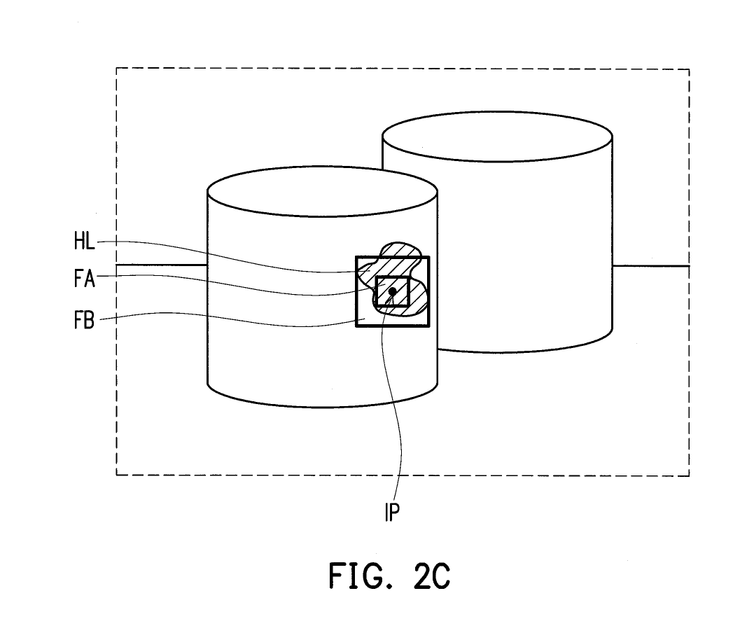

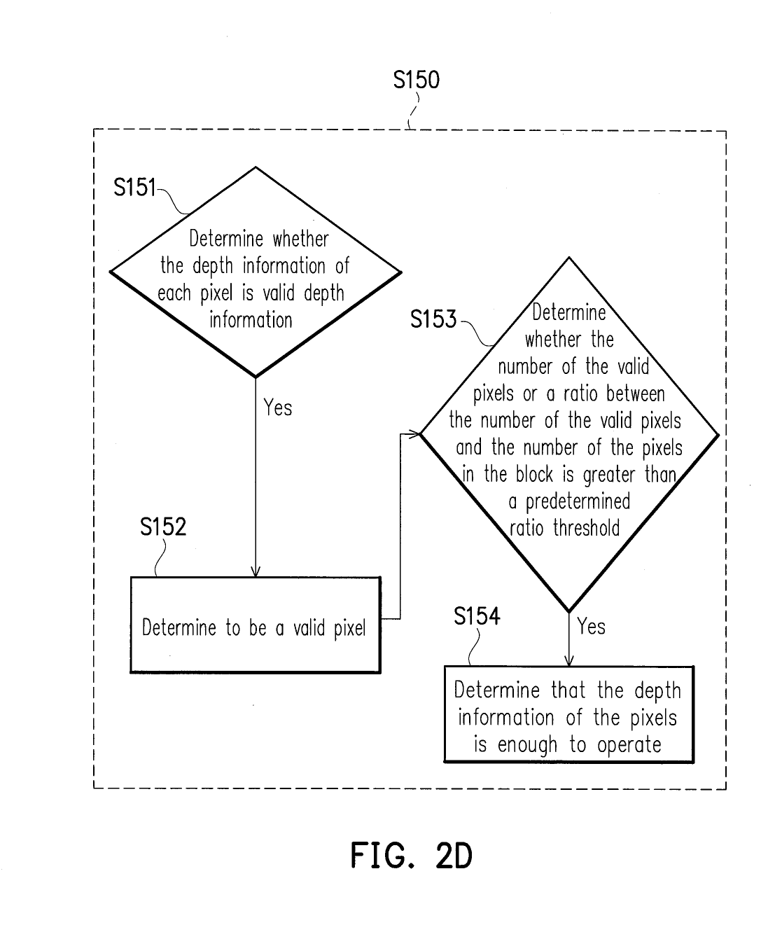

FIG. 2A is a flowchart illustrating an AF method according to an embodiment of the invention. Referring to FIG. 2 A, in the present embodiment, the AF method is, for example, executed by the AF apparatus 100 of FIG. 1. Detail steps of the AF method of the present embodiment are described below with reference of various modules in the AF apparatus 100.

First, in step S110, at least one target object is selected. To be specific, in the present embodiment, a method of selecting the target object is, for example, to receive at least one click signal for selecting the target object from the user through the AF apparatus 100 to select the target object, and to obtain a coordinate position of at least one initial focusing point IP (shown in FIG. 2C). For example, the user can select the target object through a touch action or by moving an image capturing device to a specific region. However, the invention is not limited thereto. In other embodiments, the method of selecting the target object is to perform an object detecting procedure through the AF apparatus 100 to automatically select the target object and obtain the coordinate position of the at least one initial focusing point IP. For example, the AF apparatus 100 can automatically select the target object and obtain the coordinate position of the at least one initial focusing point IP through a face detection technique, a smile detection technique or a body detection technique. However, the invention is not limited thereto. Those with ordinary skill in the art should be able to design the mechanism for selecting the target object in the AF apparatus 100 according to an actual requirement.

Then, in step S120, the first image sensor 110 and the second image sensor 120 are used to photograph the target object, and perform a procedure of three-dimensional (3D) depth estimation to generate a 3D depth map. Details of the step S120 are described below with reference of FIG. 2B.

FIG. 2B is a flowchart illustrating steps of producing the 3D depth map according to the embodiment of FIG. 2A. In the present embodiment, the step S120 of producing the 3D depth map shown in FIG. 2A includes sub steps S121, S122 and S123. Referring to FIG. 2B, in step S121, the first image sensor 110 and the second image sensor 120 are used to capture the target object to respectively generate a first image and a second image. For example, the first image is a left eye image and the second image is a right eye image. In the present embodiment, the first image and the second image can be stored in the storage unit 140 to be used in subsequent steps.

Then, in step S122, the block depth estimator 151 of the processing unit 150 performs 3D depth estimation according to the first image and the second image. In detail, the block depth estimator 151 of the processing unit 150 performs image processing through a stereoscopic vision technique to obtain a 3D coordinate position of the target object in the space and depth information of each point in the image. Then, in step S123, after the block depth estimator 151 of the processing unit 150 obtains the piece of initial depth information of each point, the block depth estimator 151 synthesise all pieces of depth information into the 3D depth map, and stores the 3D depth map in the storage unit 140 to be used in subsequent steps.

However, generally speaking, the 3D depth map generated in the step S123 probably has a plurality of holes HL (shown in FIG. 2C), so that the processing unit 150 can selectively execute a step S124 to perform preliminary optimization on the 3D depth map according to an actual situation. In detail, in the present embodiment, the method of preliminary optimization is, for example, to perform weighting processing on the piece of depth information of each point and the pieces of adjacent depth information through a image processing technique. Therefore the pieces of depth information of each point of the image can be more continuous, and meanwhile, the pieces of marginal depth information of the image can be maintained. In this way, not only the problems of inaccuracy and discontinuity of the depth information of each point recorded in the original 3D depth map are avoided, but the holes HL formed on the original 3D map can be fixed. For example, in the present embodiment, the preliminary optimization processing can be Gaussian smoothing, though the invention is not limited thereto. In other applicable embodiments, those with ordinary skill in the art can select other suitable statistic operation methods to execute the preliminary optimization processing according to an actual requirement, which is not repeated therein.

Referring to FIG. 2A, in step S130, a block covering the initial focusing point IP is selected according to the at least one initial focusing point IP of the target object through the block depth estimator 151. In detail, the block depth estimator 151 can determine a position of the block according to the coordinate position of the initial focusing point IP obtained in the step S110. Moreover, in the present embodiment, the size of the block can be defined in advance, and may have different ranges to contain different number of the pixels. For example, the size of the block is 21×21 pixels, 41×41 pixels, 81×81 pixels, etc., wherein the initial focusing point IP can serve as the center of the block, i.e. a central pixel of the block, though the invention is not limited thereto. Those with ordinary skill in the art can design the position and the size of the block according to an actual requirement, which is not repeated therein.

FIG. 2C is a schematic diagram of depth searching according to the embodiment of FIG. 2A. In step S140, the 3D depth map is queried through the block depth estimator 151 to read pieces of depth information of a plurality of pixels in the block. However, as that shown in FIG. 2C, if the coordinate position of the initial focusing point IP falls in the hole HL, the depth information of the pixel probably cannot be retrieved for later related operations, or an error focusing position is accordingly calculated to cause focusing failure. Therefore, in step S150, it is determined whether the depth information of the pixels is enough to operate, which avails performing following steps. Details of the step S150 are described below with reference of FIG. 2D.

FIG. 2D is a flowchart illustrating steps of determining whether the depth information of the pixels is enough to operate according to the embodiment of FIG. 2A. In the present embodiment, the step S150 of FIG. 2A includes sub steps S151, S152, S153 and S154. Referring to FIG. 2D, in the step S151, it is determined whether the depth information of each pixel is valid depth information through the depth information determination module 152 coupled to the block depth estimator 151. If yes, the pixel is determined to be a valid pixel (the step S152). In detail, since the cause to the holes HL in the 3D depth map is due to that the block depth estimator 151 cannot calculate aberrations of some regions, when the block depth estimator 151 performs the 3D depth estimation according to the first image and the second image. In other words. the pieces of depth information of the pixels in these regions cannot be calculated. Therefore, the method of determining whether the piece of depth information of each pixel is the piece of valid depth information can be executed through calculation during the process of the 3D depth estimation.

In detail, when the related calculation of the 3D depth estimation is performed, a specific value can be given to the pixels on the part of region in the 3D depth map where the aberration cannot be calculated. Moreover, in a subsequent calculation process, the pixels having the specific value are regarded as invalid pixels, and not included in the calculation. For example, a value range of a 10-bit pixel format image falls between 1 and 1023, and the processing unit 150 can set a value of 1023 on the pixel without the piece of valid depth information and set values of 0-1020 on the pixels having valid depth information. In this way, the depth information determination module 152 can quickly determine whether each pixel is a valid pixel, though the invention is not limited thereto. Those with ordinary skill in the art can select other suitable definition of the valid pixels according to an actual requirement, which is not repeated.

Then, in the step S153, it is determined whether the number of the valid pixels or a ratio between the number of the valid pixels and the number of the pixels in the block is greater than a predetermined ratio threshold through the depth information determination module 152. If yes, the step S154 is executed, by which it is determined that the pieces of depth information of the pixels is enough to operate. In detail, the predetermined ratio threshold can be a suitable pixel number or a numerical percentage. For example, the predetermined ratio threshold can be a numerical percentage of 30%, which represent that, the depth information determination module 152 determines that the depth information of the pixels is enough to operate when the ratio between the number of the valid pixels and the number of the pixels in the block is greater than 30%. Moreover, subsequent operations are performed according to a depth information statistic histogram of the block. It should be noticed that the above numerical ratio range is only used as an example, and a threshold value and a range magnitude thereof are not limited by the invention.

However, on the other hand, referring to FIG. 2A, in the step S154, when the depth information determination module 152 determines that the pieces of depth information of the pixels are not enough to operate, the step S155 is executed. In the step S155, the position of the block is moved or the size of the block is enlarged to read the pieces of depth information of the pixels in the block though the block depth estimator 151. For example, in the present embodiment, the size of the block is enlarged from a range FA to a range FB (shown in FIG. 2C). Then, a step S157 is executed, by which it is determined whether the size of the block is greater than a predetermined range threshold though the processing unit 150. If not, the flow returns back to the step S150 to again determine whether the depth information of the pixels is enough to operate and to perform related calculations to obtain the piece of focusing depth information of the target object. If yes, a step S159 is executed, by which it is determined that the focusing is failed, and the AF apparatus 100 is driven to execute a pan-focusing procedure, or to perform an AF procedure of contrast type focusing or does not perform focusing. For example, the predetermined range threshold can be a maximum pixel range covered by the aforementioned block, such as a range of 81×81 pixels. However, the invention is not limited thereto. Those with ordinary skill in the art can select other suitable definition of the predetermined range threshold according to an actual requirement, which is not repeated.

On the other hand, when the depth information determination module 152 determines that the pieces of depth information of the pixels is enough to operate, a step S156 shown in FIG. 2A is executed, by which a first statistic operation is performed on the pieces of depth information of the valid pixels through the block depth estimator 151 to obtain a piece of focusing depth information of the target object. In detail, a purpose of performing the first statistic operation is to reliably calculate the piece of focusing depth information of the target object to avoid focusing an incorrect target object. However, it should be noticed that a method of executing different first statistic operation would result in different focusing effects. For example, the first statistic operation could be a mean operation, a mod operation, a median operation, a minimum value operation, a quartile operation or other suitable mathematic statistical operations.

To be specific, the mean operation refers to that the average depth information of the valid pixels in the block is taken as the piece of focusing depth information of the subsequent auto focusing steps. Further, when a distribution the depth information of the valid pixels in the block is not even, the average depth information can be taken as the piece of focusing depth information to cause a focusing effect for balancing each pixel. However, an disadvantage thereof is that it is unable to correctly focus when the pieces of depth information of valid pixels is extremely uneven or difference between the pieces of depth information of pixels is too large. The mod operation is to take the piece of valid depth information with the largest number of pixels in the block as the piece of focusing depth information. The median operation is to take a middle value of the pieces of valid depth information in the block as the piece of focusing depth information, which takes both of the focusing characteristics of the mean operation and the mod operation into account.

The minimum value operation is to take the closest piece of valid depth information in the block as a reference to determine the piece of focusing depth information. However, such operation method is easy to be influenced by noises when only using the minimum value for calculation. The quartile operation is to take a first quartile or a second quartile of the pieces of valid depth information in the block as the piece of focusing depth information. Further, when the first quartile of the pieces of valid depth information in the block is taken as the piece of focusing depth information, it has a similar effect with the method of taking the closest piece of valid depth information in the block as the piece of focusing depth information. However, the influence of noises would be avoided. When the second quartile of the pieces of valid depth information in the block is taken as the piece of focusing depth information, it has a similar effect with the method of taking the middle value of the valid depth information in the block as the piece of focusing depth information.

It should be noticed that although the aforementioned statistic operation method is taken as an example to describe the method of the first statistic operation, the invention is not limited thereto. Those with ordinary skill in the art can select other suitable statistic operation methods to obtain the piece of focusing depth information of the target object according to an actual requirement, which is not repeated.

Then, after the piece of focusing depth information is obtained, a step S160 is executed, by which a focusing position regarding the target object is obtained according to the focusing depth information through the processing unit 150. In detail, the step S160 is to, a depth table may be queried according to the piece of focusing depth information, so as to obtain the focusing position regarding the target object. For example, while executing AF procedure, the focusing module 130 controls steps of a stepper motor in the AF apparatus 100 or controls a current value of a voice coil motor to respectively adjust zoom lenses of the first image sensor 110 and the second image sensor 120 to desired focusing positions, and then performs focusing. Therefore, by calibrating the stepper motor or the voice coil motor, the AF apparatus 100 can obtain a corresponding relationship between the steps of the stepper motor or the current value of the voice coil motor and clear depth of the target object in advance, and the corresponding data can be recorded in the depth table, and stored in the storage unit 140. In this way, the steps of the stepper motor or the current value of the voice coil motor corresponding to the piece of focusing depth information can be queried according to currently obtained focusing depth information of the target object, and focusing position information of the target object is obtained accordingly.

Then, in step S170, the processing unit 150 drives the AF apparatus 100 to execute the AF procedure according to the focusing position. In detail, since the focusing module 130 controls the focusing positions of the first image sensor 110 and the second image sensor 120, after obtaining the focusing position regarding the target object, the processing unit 150 can drive the focusing module 130 of the AF apparatus 100, and accordingly adjust the zoom lenses of the first image sensor 110 and the second image sensor 120 to the focusing positions, so as to complete the AF procedure.

In this way, a 3D depth map is generated through the stereoscopic vision image processing technique, and the piece of depth information of each pixel in the 3D depth map is determined. Moreover, the statistics operation is performed to obtain the focusing position. In this way, the AF apparatus and the AF method of the invention not only can be performed within a single image shooting period, but also resolve the problem of focusing error caused by depth information holes HL in the 3D depth map. Moreover, the depth information of each pixel in the block can be suitably processed by executing different statistics operation methods, so as to calculate the suitable piece of focusing depth information. Therefore, the AF apparatus 100 and the AF method provided by the present invention have a faster speed of auto focusing and optimal image stability, and also have optimal focus positioning accuracy.

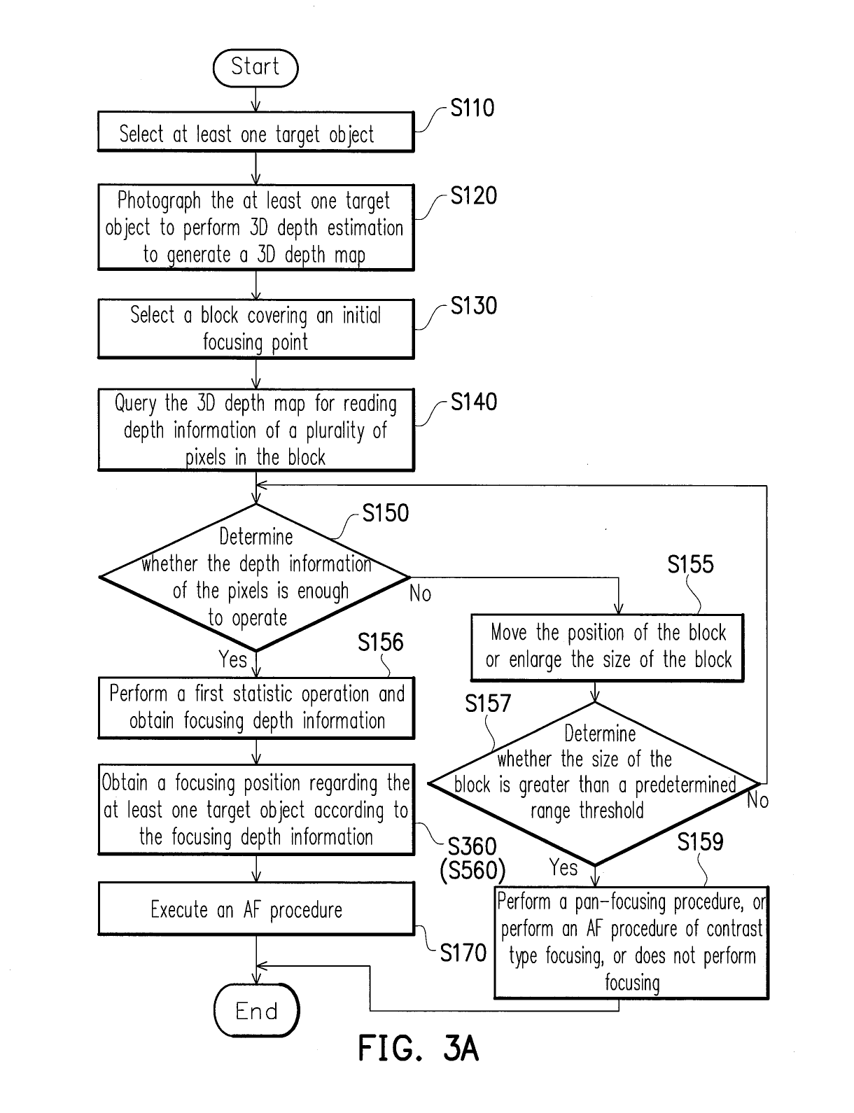

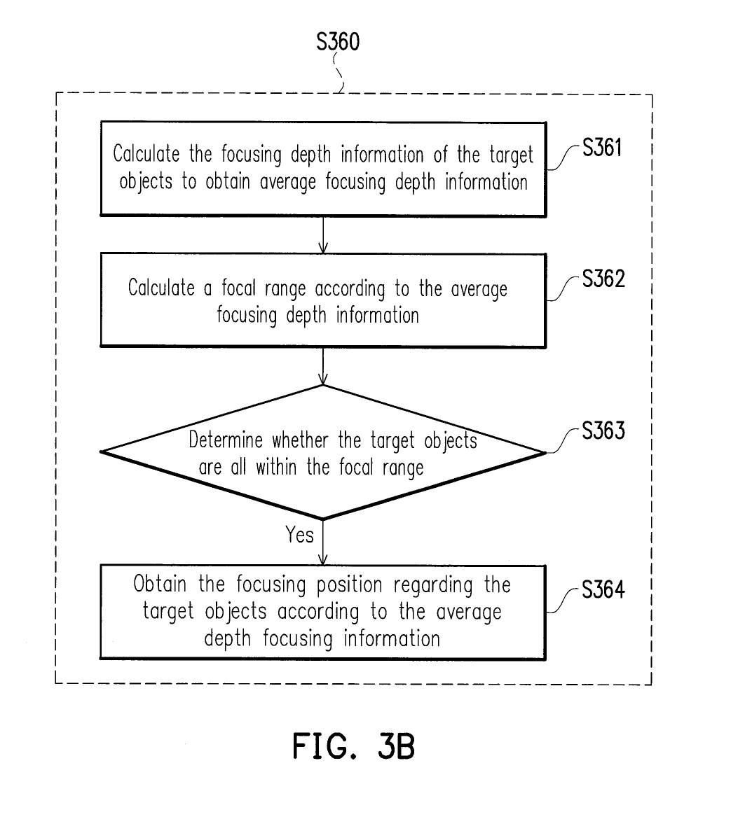

FIG. 3A is a flowchart illustrating an AF method according to anther embodiment of the invention. Referring to FIG. 3A, the AF method of the present embodiment is similar to the AF method of the embodiment of FIG. 2A, and only a difference there between is described blow with reference of FIG. 3B.

FIG. 3B is a flowchart illustrating a method of obtaining a focusing position regarding the target objects according to the embodiment of FIG. 3A. In the present embodiment, when the at least one target object are a plurality of target objects, in step S360 of FIG. 3A, the focusing position regarding the targets object is obtained according to the pieces of focusing depth information, and the step S360 further includes sub steps S361, S362, S363 and S364. Referring to FIG. 3B, first, in the step S361, the pieces of focusing depth information of the target objects is calculated through the block depth estimator 151 to obtain average focusing depth information. Then, in step S362, a focal range is calculated according to the average focusing depth information. Then, in step S363, it is determined whether the target objects are all within the focal range. If yes, in step S364, the focusing position regarding the target objects is obtained according to the average depth focusing information. In this way, the target objects to be focused all have suitable focusing effect.

Moreover, it should be noticed that the difference between the AF method of the present embodiment and the AF method of the embodiment of FIG. 2A only lies in whether the statistic operation is again performed when the focusing position information of each target object is obtained. Thus, it does not influence the aforementioned technical characteristics of applying the stereoscopic vision image processing technique to generate the 3D depth map, performing determination on the piece of depth information of each pixel in the 3D depth map, and performing the first statistic operation to obtain the piece of focusing depth information. Therefore, the AF method of the present embodiment also has the advantages described in the AF method of the embodiment of FIG. 2A, which are not repeated.

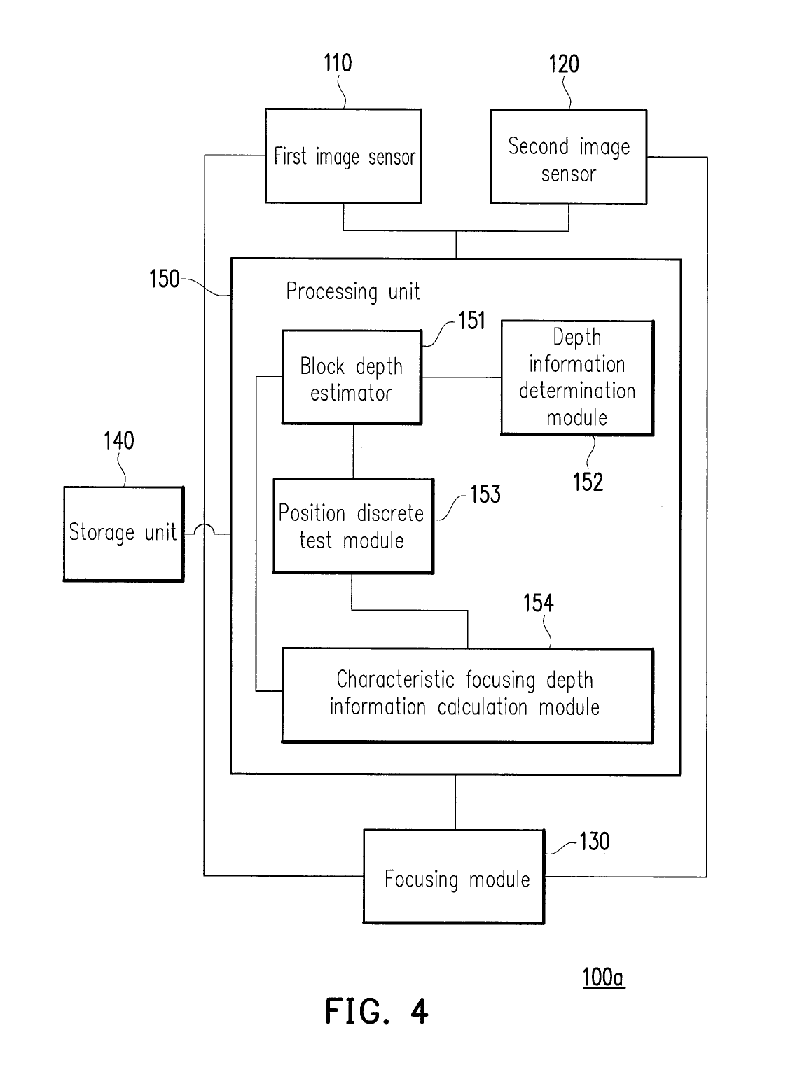

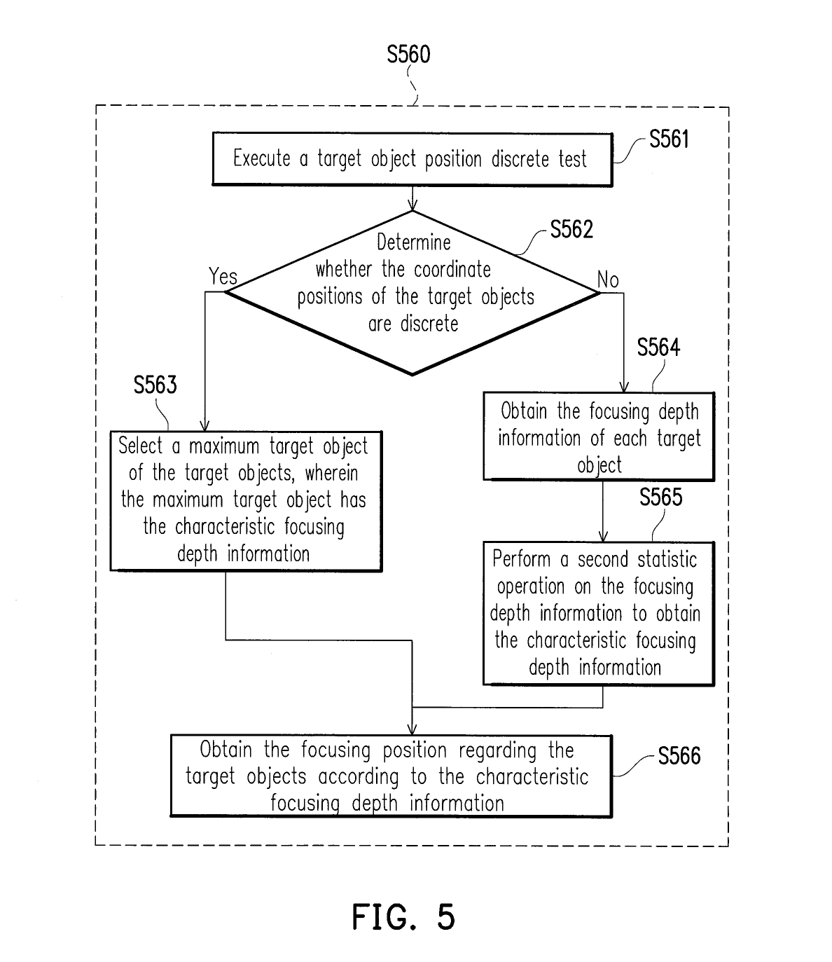

FIG. 4 is a block diagram of an AF apparatus according to another embodiment of the invention. Referring to FIG. 4, the AF apparatus 100a of the present embodiment is similar to the AF apparatus 100 of FIG. 1, and only differences there between are described below. In the present embodiment, the processing unit 150 further includes a position discrete test module 153 and a characteristic focusing depth information calculation module 154. For example, the position discrete test module 153 and the characteristic focusing depth information calculation module 154 are all functional modules implemented as hardware and/or software, wherein the hardware may be any one or a combination of hardware devices, such as a central processor (CPU), a system on chip (SOC), an application specific integrated circuit (ASIC), a digital signal processor (DSP), a chipset, a microprocessor, and the software can be an operating system (OS), a driving programs. Functions of the position discrete test module 153 and the characteristic focusing depth information calculation module 154 are described below with reference of FIG. 5.

FIG. 5 is a flowchart illustrating another method of obtaining the focusing position regarding the target objects according to the embodiment of FIG. 3A. In the present embodiment, when the at least one target object are a plurality of target objects, the step S560 of obtaining the focusing position regarding the target object according to the piece of focusing depth information further includes sub steps S561, S562, S563, S564, S565 and S566. Details of the step S560 are described below with reference of the position discrete test module 153 and the characteristic focusing depth information calculation module 154.

Referring to FIG. 5, first, in the step S561, a target object position discrete test is executed through the position discrete test module 153. In detail, in the present embodiment, the position discrete test module 153 is coupled to the block depth estimator 151 to obtain the coordinate position of the initial focusing point IP and execute a related test method. For example, the target object position discrete test can be a standard deviation test, a variance test, an entropy test or other suitable test methods, though the invention is not limited thereto. In other embodiments, those with ordinary skill in the art can select other suitable test methods to execute the target object position discrete test according to an actual requirement, which is not repeated.

Then, in the step S562, it is determined whether the coordinate positions of the target objects are discrete, and different methods of obtaining the focusing position are selected accordingly. In detail, in the present embodiment, the characteristic focusing depth information calculation module 154 is coupled to the block depth estimator 151 and the position discrete test module 153 to obtain the piece of focusing depth information of each target object, and accordingly obtain related characteristic focusing depth information. For example, when it is determined that the coordinate positions of the target objects are discrete, the step S563 is executed, by which a maximum target object of the target objects is selected through the characteristic focusing depth information calculation module 154, wherein the maximum target object has the characteristic focusing depth information. On the other hand, when it is determined that the coordinate positions of the target object are convergent, the step S564 is executed to obtain the piece of focusing depth information of each target object.

Then, in the step S565, a second statistic operation is performed on the pieces of focusing depth information to obtain the characteristic focusing depth information, wherein the second statistic operation is, for example, a mod operation. For example, a method of executing the mod operation is to calculate the piece of focusing depth information of a target object which has the most valid pixels of the target objects that are covered by the block, though the invention is not limited thereto. In other embodiments, those with ordinary skill in the art can select other method for executing the mod operation according to an actual requirement. For example, when the numbers of invalid pixels covered by different target objects are the same, the method for executing the mod operation can also calculate the piece of focusing depth information of the target object with a maximum surface area and perform follow up operations, which is not repeated.

Then, in the step S566, the focusing position regarding the target objects is obtained according to the characteristic focusing depth information obtained in the step S563 or the step S565. In the present embodiment, the method of the step S566 has been described in detail in the step S160 of the embodiment of FIG. 2A, which is not repeated. Moreover, it should be noticed that the difference between the AF method of the present embodiment and the AF method of the aforementioned embodiment only lies in the statistic operation performed when the focusing position information of each target object is obtained. Thus, it does not influence the aforementioned technical characteristics of applying the stereoscopic vision image processing technique to generate the 3D depth map, performing determination on the piece of depth information of each pixel in the 3D depth map and performing the first statistic operation to obtain the piece of focusing depth information. Therefore, the AF method of the present embodiment also has the advantages described in the AF method of the aforementioned embodiments, which are not repeated.

As described above, in the AF apparatus and the AF method provided by embodiments of the invention, a 3D depth map is generated through the stereoscopic vision image processing technique, and the piece of depth information of each pixel in the 3D depth map is determined. Moreover, the statistics operation is performed to obtain the focusing position. In this way, the AF apparatus and the AF method of the invention not only can be performed within a single image shooting period, but also resolve the problem of focusing error caused by depth information “holes” in the 3D depth map. Moreover, the AF apparatus and the AF method of the invention can also suitably process the depth information of each pixel in the block by executing different statistics operation methods, so as to calculate the suitable piece of focusing depth information. Therefore, the AF apparatus and the AF method provided by the present invention have a faster speed of auto focusing and optimal image stability, and also have optimal focus positioning accuracy.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An auto focus (AF) method, adapted to an AF apparatus which has a first image sensor and a second image sensor, the AF method comprising:
selecting at least one target object and photographing the at least one target object by the first image sensor and the second image sensor to perform a procedure of three-dimensional (3D) depth estimation, so as to generate a 3D depth map;
selecting a block covering at least one initial focusing point according to the at least one initial focusing point of the at least one target object;
querying the 3D depth map for reading pieces of depth information of a plurality of pixels in the block;
determining whether the pieces of depth information of the pixels is enough to operate, if yes, performing a first statistics operation on the pieces of depth information of the pixels to obtain a piece of focusing depth information, and if not, moving the position of the block or enlarging the size of the block to obtain the piece of focusing depth information; and
obtaining a focusing position regarding the at least one target object according to the piece of focusing depth information, and driving the AF apparatus to perform an AF procedure according to the focusing position.

2. The AF method as claimed in claim 1, wherein the step of determining whether the depth information of the pixels is enough to operate comprises:
determining whether the piece of depth information of each pixel is a piece of valid depth information, and if yes, determining the pixel to be a valid pixel; and
determining whether a quantity of the valid pixels or a ratio between the valid pixels and the pixels is greater than a predetermined ratio threshold.

3. The AF method as claimed in claim 1, wherein after the step of enlarging the size of the block, the AF method further comprises:
determining whether the size of the block is greater than a predetermine range threshold, and if not, returning to the step of determining whether the depth information of the pixels is enough to operate, and if yes, determining that the focusing is failed and driving the AF apparatus to perform a pan-focusing procedure, or to perform an AF procedure of contrast type focusing or does not perform focusing.

4. The AF method as claimed in claim 1, wherein a method for selecting the at least one target object comprises:
receiving at least one click signal for selecting the at leas one target object from a user through the AF apparatus or executing an object detecting procedure through the AF apparatus to automatically select the at least one target object, and obtaining a coordinate position of the at least one initial focusing point.

5. The AF method as claimed in claim 1, wherein when the at least one target object are a plurality of target objects, the step of obtaining the focusing position regarding the target objects comprises:
calculating the pieces of focusing depth information of the target objects to obtain average focusing depth information;
calculating a focal range according to the average focusing depth information; and
determining whether the target objects are all within the focal range, and if yes, obtaining the focusing position regarding the target objects according to the average focusing depth information.

6. The AF method as claimed in claim 4, wherein when the at least one target object are a plurality of target objects, the AF method further comprises:
executing a target object position discrete test; and
determining whether the coordinate positions of the target objects are discrete.

7. The AF method as claimed in claim 6, wherein the target object position discrete test is a standard deviation test, a variance test or an entropy test.

8. The AF method as claimed in claim 6, wherein when it is determined that the coordinate positions of the target objects are discrete, the step of obtaining the focusing position regarding the target objects comprises:
selecting a maximum target object from the target objects, wherein the maximum target object has characteristic focusing depth information; and
obtaining the focusing position regarding the target objects according to the characteristic focusing depth information.

9. The AF method as claimed in claim 6, wherein when it is determined that the coordinate positions of the target objects are convergent, the step of obtaining the focusing position regarding the target objects comprises:
obtaining each piece of focusing depth information of the target objects;
performing a second statistics operation on the pieces of focusing depth information to obtain the characteristic focusing depth information, wherein the second statistics operation is a mod operation; and
obtaining the focusing position regarding the target objects according to the characteristic focusing depth information.

10. The AF method as claimed in claim 1, wherein the first statistics operation is a mean operation, a mod operation, a median operation, a minimum value operation or a quartile operation.

11. An AF apparatus, comprising:
a first image sensor and a second image sensor, photographing at least one target object;
a focusing module, controlling a focusing position of the first image sensor and the second image sensor; and
a processing unit, coupled to the first image sensor, the second image sensor and the focusing module, wherein the processing unit comprises:
a block depth estimator, performing a procedure of 3D depth estimation to generate a 3D depth map, selecting a block covering at least one initial focusing point according to the at least one initial focusing point of the at least one target object, and querying the 3D depth map for reading pieces of depth information of a plurality of pixels in the block; and
a depth information determination module, coupled to the block depth estimator, wherein the depth information determination module determines whether the pieces of depth information of the pixels is enough to operate, if not, the block depth estimator moves the position of the block or enlarge the size of the block for reading the pieces of depth information of the pixels in the block, and if yes, the processing unit drives the block depth estimator to perform a first statistics operation on the pieces of depth information of the pixels to obtain a piece of focusing depth information, and the processing unit obtains a focusing position regarding the at least one target object according to the piece of focusing depth information, and drives the AF apparatus to perform an AF procedure according to the focusing position.

12. The AF apparatus as claimed in claim 11, wherein the depth information determination module determines whether the piece of depth information of each pixel is valid depth information, and if yes, determines the pixel to be a valid pixel, and the depth information determination module further determines whether a quantity of the valid pixels or a ratio between the valid pixels and the pixels is greater than a predetermined ratio threshold, and if yes, determines that the pieces of depth information of the pixels are enough to operate.

13. The AF apparatus as claimed in claim 11, further comprising:
a storage unit, coupled to the processing unit, and configured to store the 3D depth map and a depth table, wherein the processing unit queries the depth table according to the piece of focusing depth information to obtain the focusing position regarding the target object.

14. The AF apparatus as claimed in claim 11, wherein the processing unit further comprises:
a position discrete test module, coupled to the block depth estimator, obtaining a coordinate position of the at least one initial focusing point, executing a target object position discrete test when the at least one target object are a plurality of target objects, and determining whether the coordinate positions of the target objects are discrete.

15. The AF apparatus as claimed in claim 14, wherein the processing unit further comprises:
a characteristic focusing depth information calculation module, coupled to the block depth estimator and the position discrete test module and obtaining each piece of focusing depth information of the target objects to obtain characteristic focusing depth information, wherein the processing unit obtain the focusing position regarding the target objects according to the characteristic focusing depth information.
